(19) United States
(12) Patent Application Publication
(10) Pub. No.: US 2023/0401551 A1
(43) Pub. Date: Dec. 14, 2023

(54) Self-Service Kiosk with Movable Display

(71) Applicant: Bank of America Corporation, Charlotte, NC (US)

(72) Inventors: Geoffrey George Aslaksen, Matthews, NC (US); Neal Aaron Slensker, Fort Mill, SC (US); Anusha Addagudi, Centennial, CO (US); Matthew Aaron Whitehurst, Indian Land, SC (US); Vanesa Mitrevski, Indian Head Park, IL (US); Srinivasa Gadiparthy, Frisco, TX (US); James Gasper Mathias, Charlotte, NC (US); Lynda Finn, Fort Mill, SC (US); Michael Young, Davidson, NC (US)

(21) Appl. No.: 17/835,135

(22) Filed: Jun. 8, 2022

(51) Int. Cl. G06Q 20/18; G07F 19/00

(52) U.S. Cl. CPC G06Q 20/18; G07F 19/207; G07F 19/205

(57) ABSTRACT

Arrangements for adjusting a movable display portion of a self-service kiosk are provided. In some aspects, sensor data may be received from one or more sensors associated with a self-service kiosk. The sensor data may be analyzed to determine one or more dimensions of the vehicle. Based on the analyzed sensor data, a position to which a movable display portion of the self-service kiosk should be adjusted may be identified. In some examples, an instruction causing the movable display portion to adjust from a first, current position to the identified adjusted position may be generated and executed. The user may then initiate the transaction using one or more components of the self-service kiosk in the adjusted, second position. The transaction may be processed by the self-service kiosk. When the transaction is completed, an instruction causing the movable display portion to return to the first position may be generated and executed.

### BACKGROUND

Aspects of the disclosure relate to electrical computers, systems, and devices for providing a self-service kiosk with an adjustable, movable display.

Self-service kiosks generally have fixed displays. While this arrangement may be acceptable for walk-up kiosks, for drive-up kiosks, this can make processing a transaction difficult. For instance, drivers having low riding vehicles might not be able to reach keys to select options, a deposit slot, or the like. Further, the display may be positioned such that, relative to the driver of the vehicle, it may be difficult or impossible to read a display screen of the self-service kiosk. Accordingly, it would be advantageous to have a self-service kiosk with a movable, adjustable display.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with adjusting one or more components of a self-service kiosk.

In some aspects, sensor data may be received from one or more sensors associated with a self-service kiosk. The sensor data may be analyzed to determine one or more dimensions of the vehicle, such as a height of the vehicle relative to a ground surface, a distance from a driver side door to a front face of the self-service kiosk, or the like). Based on the analyzed sensor data, a position to which a movable display portion of the self-service kiosk should be adjusted may be identified.

In some examples, an instruction causing the movable display portion to adjust from a first, current position to the identified adjusted position may be generated and executed. The user may then initiate the transaction using one or more components of the self-service kiosk in the adjusted, second position. The transaction may be processed by the self-service kiosk.

Upon detecting completion of the transaction, an instruction causing the movable display portion to return to the first position may be generated and executed.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing functions associated with a self-service kiosk with a movable display portion in accordance with one or more aspects described herein;

FIGS. 2A and 2B illustrate front views of an example self-service kiosk with a movable display portion in accordance with one or more aspects described herein;

FIGS. 2C and 2D illustrate side views of the example self-service kiosk with a movable display portion in accordance with one or more aspects described herein;

FIGS. 3A-3E depict an illustrative event sequence for implementing functions associated with a self-service kiosk with a movable display portion in accordance with one or more aspects described herein;

FIG. 4 illustrates an illustrative method for implementing functions associated with a self-service kiosk with a movable display portion according to one or more aspects described herein;

FIG. 5 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, drive-up self-service kiosks, such as automated teller machines (ATMs), automated teller assistants (ATAs) and the like, generally include a fixed display, keypad, card reader, and the like. This can make processing transaction difficult for users having vehicles of varying heights that might not align with the standard position of the self-service kiosk. Accordingly, aspects described herein are directed to a self-service kiosk having a movable display portion that may be adjusted to accommodate different vehicles.

For instance, in some examples, sensor data associated with one or more dimensions of a vehicle (e.g., height of a vehicle, distance from a ground surface to a hood of a vehicle, or the like) may be captured and analyzed. The sensor data may be captured using light detection and ranging (LiDAR) to accurately determine one or more dimensions. Based on the analyzed data, a second position to which the movable display portion should be adjusted may be determined. An instruction causing the movable display portion to adjust from a first position to the second position may be generated and executed. In some examples, the movable display portion may be moved automatically and without any user interaction.

Upon completion of a transaction at the self-service kiosk, the movable display portion may be adjusted to return to a first or default position from the second position.

These and various other arrangements will be discussed more fully below.

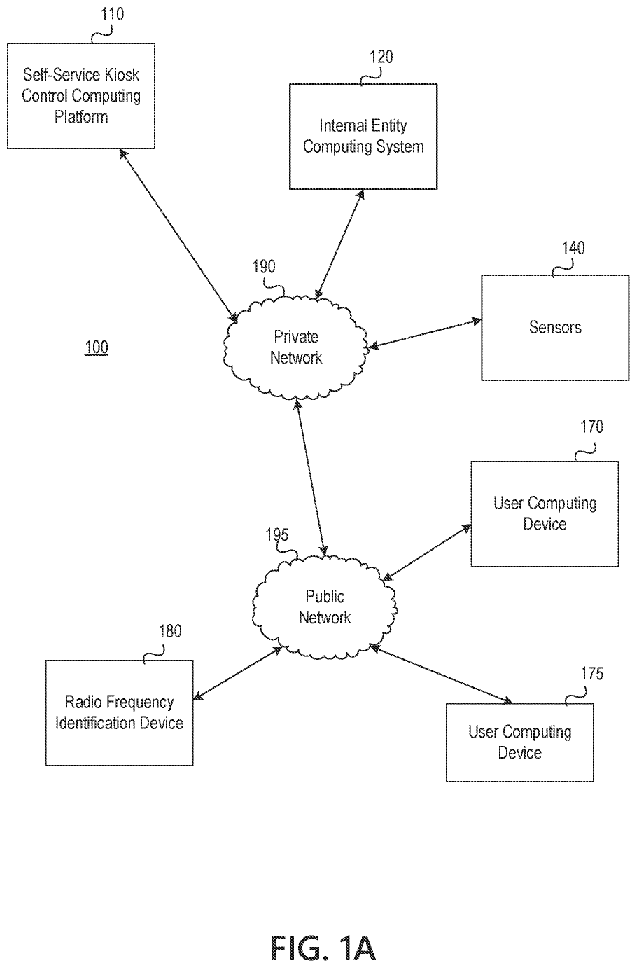

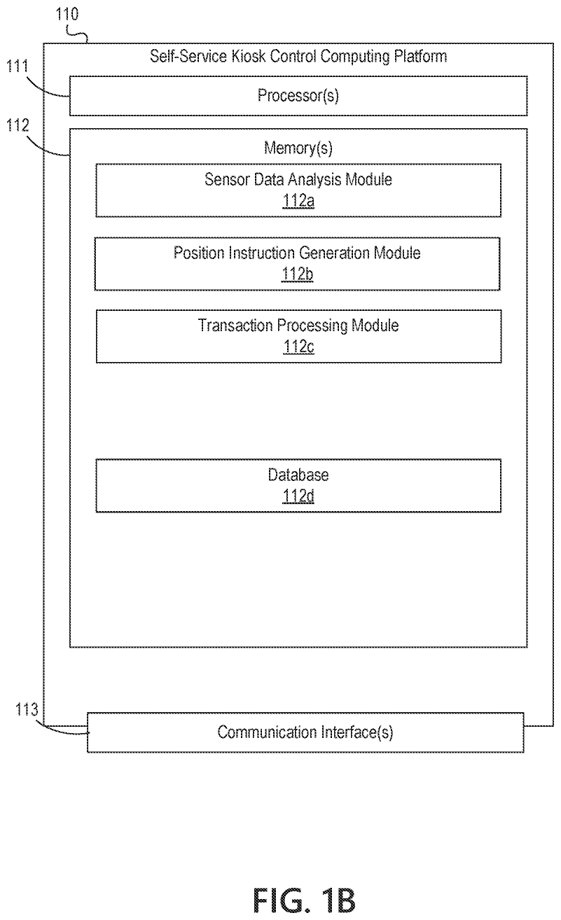

FIGS. 1A-1B depict an illustrative computing environment for implementing self-service kiosk display control functions in accordance with one or more aspects described herein. Referring to FIG. 1A, computing environment 100 may include one or more computing devices and/or other computing systems. For example, computing environment 100 may include self-service kiosk control computing platform 110, internal entity computing system 120, sensors 140, user computing device 170, user computing device 175, and/or radio frequency identification device 180. Although one internal entity computing system 120, two user computing devices 170, 175, and one radio frequency identification device 180 are shown, any number of systems or devices may be used without departing from the invention.

Self-service kiosk control computing platform 110 may be configured to perform intelligent, dynamic and efficient self-service kiosk control functions, including adjusting or moving a movable display, processing transactions, and the like. The self-service kiosk control computing platform 110 may be part of a self-service kiosk (e.g., a same physical device) or may be a separate device connected to or in communication with one or more self-service kiosks.

Self-service kiosk control computing platform 110 may receive, e.g., from one or more sensors 140, radio frequency identification device 180, user computing device 170, user computing device 175, or the like, data associated with a vehicle, dimension of a vehicle, or the like, at a self-service kiosk. The self-service kiosk control computing platform 110 may analyze the data to determine an appropriate position for a movable display portion of the self-service kiosk and may generate an instruction or command causing the self-service kiosk to move the movable display portion from a first position to a second position. In some examples, moving the movable display portion may include moving a user interface and/or a deposit slot, card reader, keypad, cash dispensing slot, and the like. In some arrangements, a user may have an option to further adjust or move the movable display to “fine tune” a desired position.

The self-service kiosk may receive user input selecting one or more transaction options that may be processed by the self-service kiosk control computing platform 110 and the transaction may be processed to completion. Upon detecting completion of the transaction, the self-service kiosk control computing platform 110 may generate an instruction or command causing the movable display portion to return to a previous position (e.g., a default position).

Internal entity computing system 120 may be or include one or more computing devices or systems (e.g., servers, server blades, or the like) that may host or execute one or more applications for processing transactions, storing user data, and the like. For instance, internal entity computing system 120 store account data, user data, user authentication data (e.g., username and password, personal identification number, biometric data, or the like) and the like, and/or may execute one or more functions to update an account ledger, process transactions, and the like.

Sensors 140 may include one or more sensors configured to detect a presence of a vehicle at a self-service kiosk, capture position or dimension data of the vehicle and transmit the data to the self-service kiosk control computing platform 110. For instance, sensors 140 may include one or more laser sensors, light detection and ranging (LiDAR) sensors, radio frequency identification sensors, ultrasonic sensors, image capture devices, license plate readers, or the like. The sensors 140 may be arranged at a self-service kiosk (e.g., on an exterior of the self-service kiosk) or on an adjacent building or structure to accurately capture data associated with vehicles approaching the self-service kiosk.

Radio frequency identification device 180 may be or include a radio frequency identification tag and/or reader that may be detected by or may detect a radio frequency identification data or reader arranged in sensors 140 at the self-service kiosk. In some examples, the radio frequency identification device 180 may be positioned in the vehicle approaching the self-service kiosk and may detect or be detected by a radio frequency identification device associated with sensors 140.

User computing device 170 and/or user computing device 175 may be or include one or more user devices, such as smartphones, wearable devices, laptop computers, tablets, or the like, that may be associated with one or more users. In some examples, a user may transmit (e.g., via an application executing on user computing device 170 and/or user computing device 175) a notification to the self-service kiosk control computing platform 110 that the user is approaching the self-service kiosk. That data may be received and a predetermined or learned position of the display of the self-service kiosk for the user may be retrieved to position the display in the predetermined or learned position.

As mentioned above, computing environment 100 also may include one or more networks, which may interconnect one or more of self-service kiosk control computing platform 110, internal entity computing system 120, sensors 140, user computing device 170, user computing device 175, and/or radio frequency identification device 180. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, self-service kiosk control computing platform 110, internal entity computing system 120, and sensors 140, may be associated with an enterprise organization (e.g., a financial institution), and private network 190 may be associated with and/or operated by the organization, and may include one or more networks (e.g., LANs, WANs, virtual private networks (VPNs), or the like) that interconnect self-service kiosk control computing platform 110, internal entity computing system 120, sensors 140, and one or more other computing devices and/or computer systems that are used by, operated by, and/or otherwise associated with the organization. Public network 195 may connect private network 190 and/or one or more computing devices connected thereto (e.g., self-service kiosk control computing platform 110, internal entity computing system 120, sensors 140) with one or more networks and/or computing devices that are not associated with the organization. For example, user computing device 170, user computing device 175, and/or radio frequency identification device 180, might not be associated with an organization that operates private network 190 (e.g., because user computing device 170, user computing device 175, and/or radio frequency identification device 180 may be owned, operated, and/or serviced by one or more entities different from the organization that operates private network 190, one or more customers of the organization, one or more employees of the organization, public or government entities, and/or vendors of the organization, rather than being owned and/or operated by the organization itself), and public network 195 may include one or more networks (e.g., the internet) that connect user computing device 170, user computing device 175, and/or radio frequency identification device 180 to private network 190 and/or one or more computing devices connected thereto (e.g., self-service kiosk control computing platform 110, internal entity computing system 120, sensors 140).

Referring to FIG. 1B, self-service kiosk control computing platform 110 may include one or more processors 111, memory 112, and communication interface 113. A data bus may interconnect processor(s) 111, memory 112, and communication interface 113. Communication interface 113 may be a network interface configured to support communication between self-service kiosk control computing platform 110 and one or more networks (e.g., private network 190, public network 195, or the like). Memory 112 may include one or more program modules having instructions that when executed by processor(s) 111 cause self-service kiosk control computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of self-service kiosk control computing platform 110 and/or by different computing devices that may form and/or otherwise make up self-service kiosk control computing platform 110.

For example, memory 112 may have, store and/or include sensor data analysis module 112a. Sensor data analysis module 112a may store instructions and/or data that may cause or enable the self-service kiosk control computing platform 110 receive data from one or more sensors 140 (e.g., LiDAR sensors, radio frequency identification sensors, ultrasonic sensors, user computing device data, motion sensors, image capture devices, and the like) and analyze the data to determine an appropriate or desired position for the movable display of the self-service kiosk. For instance, a dimension of a vehicle, height of a vehicle from a ground surface, height of a hood of a vehicle relative to the ground surface, distance between a driver side door of the vehicle and a front surface of the self-service kiosk, or the like, may be captured by one or more sensors 140 and transmitted to the sensor data analysis module 112a. Based on the data, the sensor data analysis module 112a may determine an appropriate position for the movable display portion (e.g., based on a determined or likely height of a driver side window of the vehicle, a likely position of the driver, or the like).

Self-service kiosk control computing platform 110 may further have, store and/or include position instruction generation module 112b. Position instruction generation module 112b may store instructions and/or data that may cause or enable the self-service kiosk control computing platform 110 to generate an instruction to move the movable display portion to a position determined based on analyzed sensor data or other data and cause the movable display portion to move the position. In some examples, generating the instruction and/or causing the movable display portion to move relative to the remainder of the self-service kiosk may include moving the movable display portion in a vertical direction (e.g., up or down relative to a remainder of the self-service kiosk) to accommodate vehicles of different heights. Additionally or alternatively, generating the instruction and/or causing the movable display portion to move may include moving the movable display portion in a horizontal direction (e.g., away from or toward a remainder of the self-service kiosk) to accommodate vehicles that are close to or not close enough to the self-service kiosk for the driver to reach the keypad, card reader or the like.

Self-service kiosk control computing platform 110 may further have, store and/or include transaction processing module 112c. Transaction processing module 112c may store instructions and/or data that may cause or enable the self-service kiosk control computing platform1 110 to receive user input (e.g., via a self-service kiosk) to process a transaction (e.g., withdraw funds, make a deposit, check a balance). The transaction processing module 112c may retrieve data from one or more internal systems, e.g., internal entity computing system 120, to determine an account balance, authorize the transaction, authenticate the user, and the like. The transaction processing module 112c may then generate one or more instructions causing the self-service kiosk to process the transaction (e.g., dispense funds, open a deposit slot, or the like).

Self-service kiosk control computing platform 110 may further have, store, and/or include a database 112d. Database 112d may store data associated user preferences, pre-stored or predetermined display positions, and the like. In some examples, users may store a display position (e.g., in association with a user identifier or user account). Accordingly, the user may indicate (e.g., via a user device) that the user is approaching the self-service kiosk and the stored position may be retrieved from database 112d and an instruction to move the display to the stored position may be generated and executed by the self-service kiosk. Various other data may be stored in the database 112d without departing from the invention.

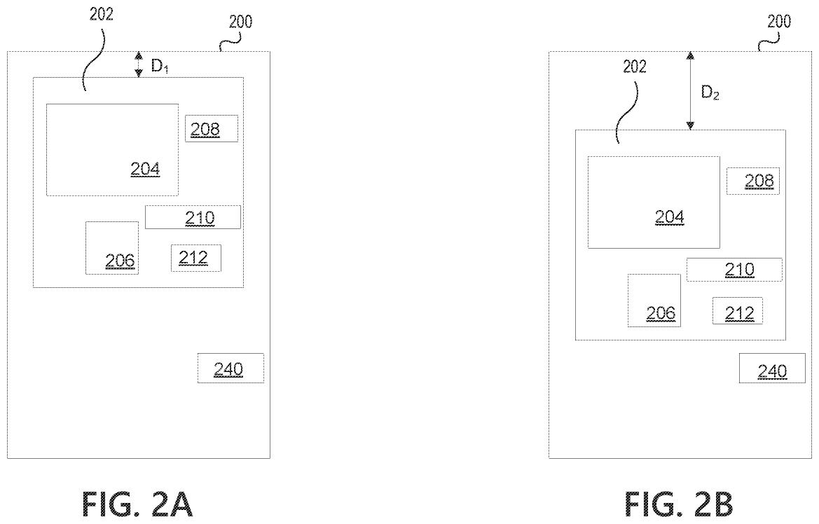

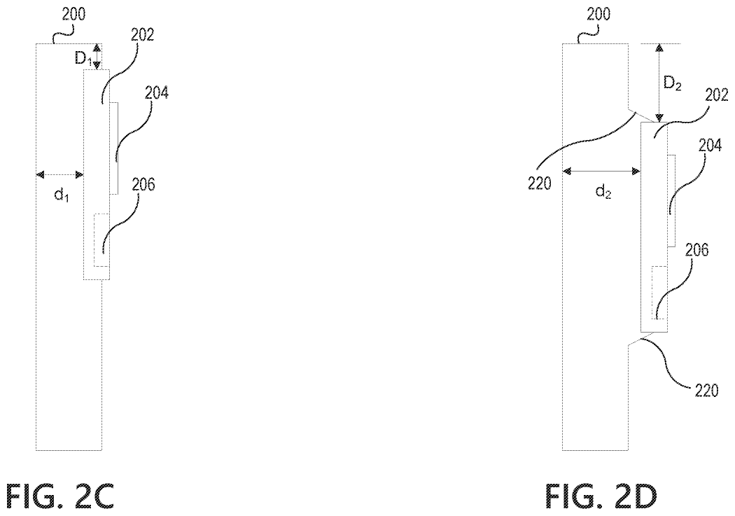

FIGS. 2A and 2B illustrate front views of an example self-service kiosk 200 in accordance with one or more aspects described herein. FIGS. 2C and 2D illustrate side views of the example self-service kiosk 200 in accordance with one or more aspects described herein.

As shown in FIGS. 2A and 2B, the self-service kiosk 200 includes a movable display portion 202 that, for example, includes a user interface display 204, keypad 206, deposit aperture 208, cash dispensing slot 210, and card reader 212. Although user interface display 204, keypad 206, deposit aperture 208, cash dispensing slot 210 and card reader 212 are shown as part of the movable portion (e.g., those features move when the display is adjusted) in some examples, one or more of user interface display 204, keypad 206, deposit aperture 208, cash dispensing slot 210 and/or card reader 212 may be arranged outside of movable portion 202 and may remain stationary (e.g., as the movable display portion 202 is moved relative to a remainder of the self-service kiosk 200.

As discussed above, self-service kiosk 200 may include self-service kiosk control computing platform 110 (e.g., in a same physical device) or may be connected to or in communication with self-service kiosk control computing platform 110.

FIG. 2A illustrates movable portion 202 in a first position a distance D₁ from a top of the self-service kiosk 200. In some examples, the first position may be a default position to which the movable display portion 202 may return (e.g., upon completion of a transaction by a user).

FIG. 2B illustrates movable display portion 202 in a second, adjusted position a distance D₂ (e.g., a greater distance indicating a lower position of the movable display portion 202) from the top of the self-service kiosk 200. In some examples, the second, adjusted position may be a position identified or determined based on sensor data received from, for example, sensors 240, from a user computing device 170, 175, retrieved from a database 112d, or the like. Although FIGS. 2A-2D illustrate the movable display portion 202 in two distinct positions, the movable display portion 202 may be positioned in potential infinite positions along a surface of the self-service kiosk 200. For instance, the self-service kiosk 200 may have a finite track or defined path that enables or defines the area of movement of the movable display portion 202 in a vertical direction. The movable portion 202 may be adjusted using one or more motors, servo motors, or the like, and may be stopped at any position along the track or path based on the analyzed sensor data, or the like. Additionally or alternatively, the self-service kiosk 200 may include one or more adjustment buttons or options (e.g., on keypad 206) that may enable a user (e.g., a driver of a vehicle) to further adjust a position of the movable display portion 202 (e.g., either vertically or horizontally). This may enable more precise positioning of the movable display portion 202 for the user.

FIGS. 2C and 2D further illustrate the self-service kiosk 200 having the movable portion 202 in a third position and a fourth position, respectively. As shown in FIG. 2C, the movable portion is in a first vertical position D₁ from the top of the self-service kiosk 200 but also a first horizontal position d₁ from a vertical reference surface (e.g. a rear of the self-service kiosk, a wall of a building into which the self-service kiosk 200 is set, or the like). FIG. 2D illustrates the movable display portion 202 in the second vertical position a distance D₂ from the top of the self-service kiosk and in a second horizontal position d₂ from the reference surface. Accordingly, positioning the movable portion 202 may include raising or lowering the movable display portion 202 with respect to the self-service kiosk 200 and/or moving the movable portion toward or away from the vehicle or user. In some examples, one or more articulating arms 220 may be used to move the movable display portion 202 toward or away from the vehicle. Various other devices for moving the movable portion may be used without departing from the invention.

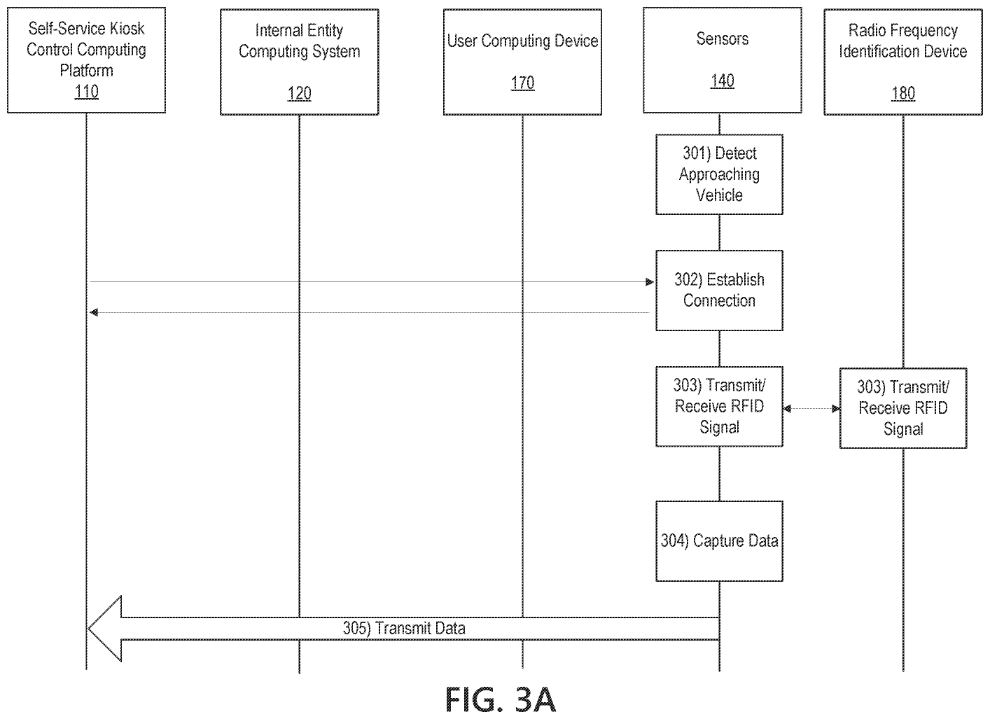

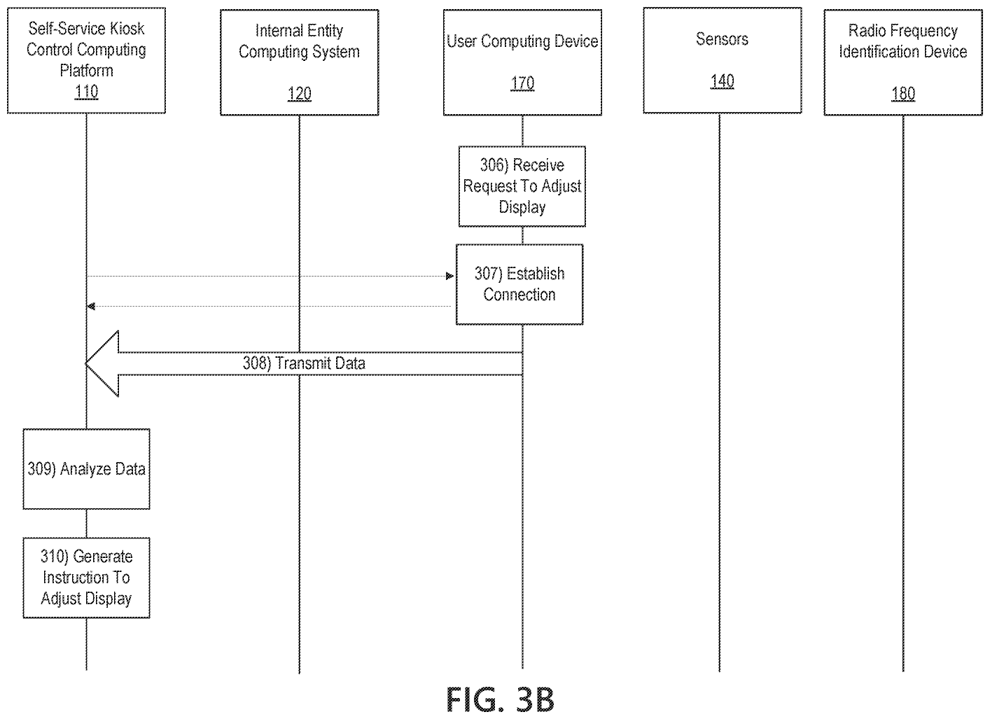

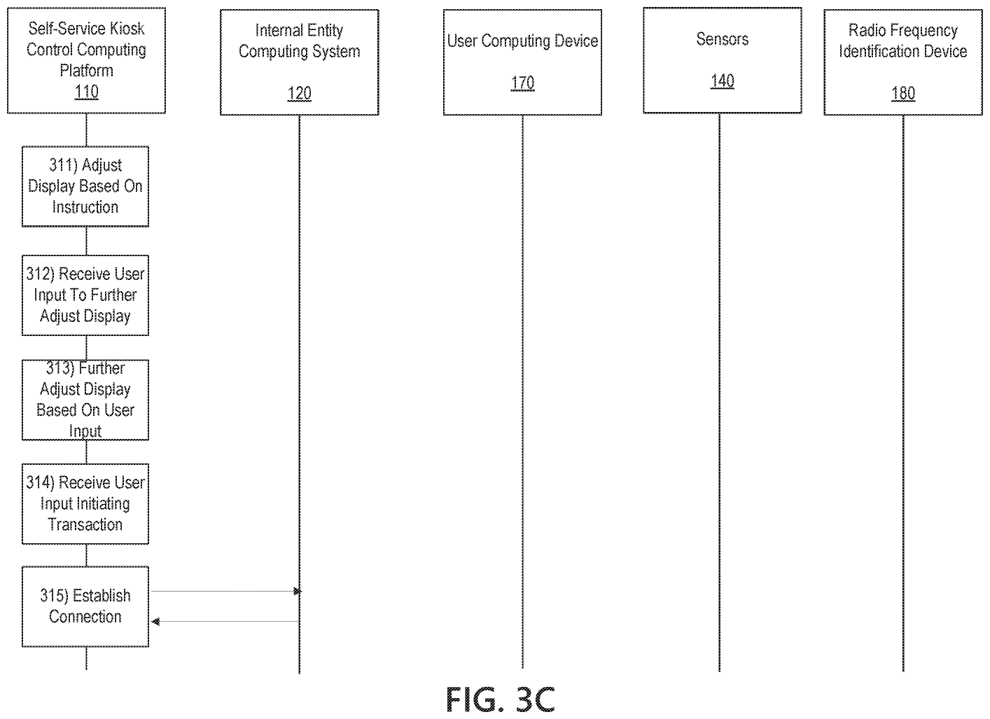

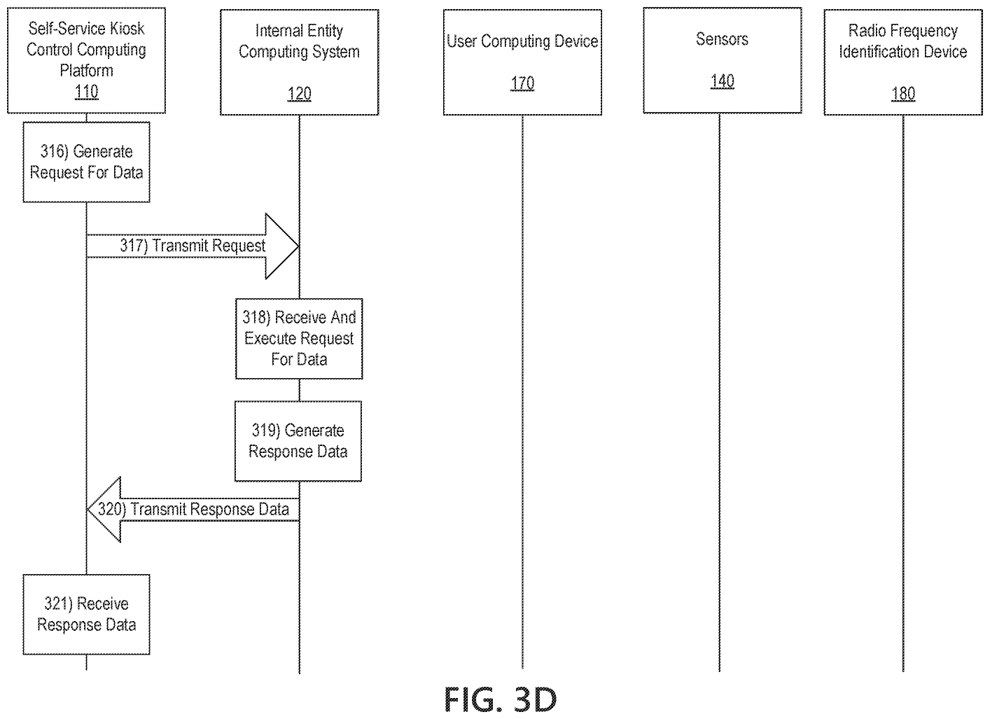

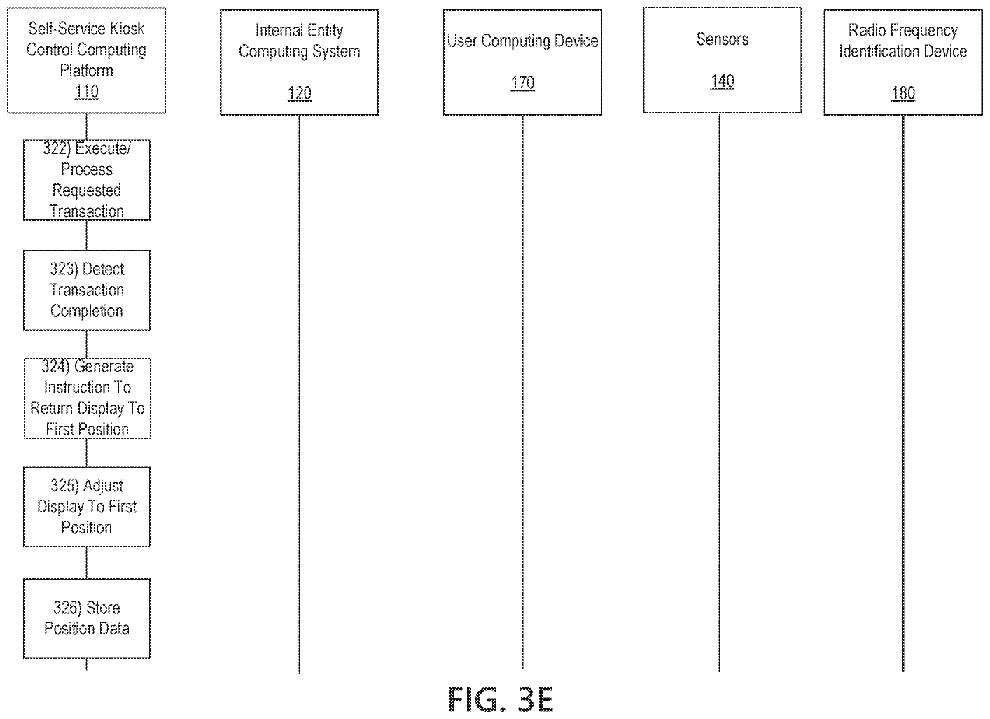

FIGS. 3A-3E depict one example illustrative event sequence for implementing a self-service kiosk with movable or adjustable display in accordance with one or more aspects described herein. The events shown in the illustrative event sequence are merely one example sequence and additional events may be added, or events may be omitted, without departing from the invention. Further, one or more processes discussed with respect to FIGS. 3A-3E may be performed in real-time or near real-time.

With reference to FIG. 3A, at step 301, one or more sensors 140 may detect a vehicle approaching a self-service kiosk. For instance, a driver pulls up in a vehicle to a drive-up self-service kiosk, one or more sensors 140 may detect a presence of the vehicle and, in some examples, activate one or more additional sensors (e.g., a motion sensor may detect the approaching vehicle and, based on the detected motion, a LiDAR sensor, ultrasonic sensor, image capture device, or other additional sensor may be activated).

At step 302, sensors 140 may connect to self-service kiosk control computing platform 110. For instance, a first wireless connection may be established between one or more of the sensors 140 and the self-service kiosk control computing platform 110. Upon establishing the first wireless connection, a communication session may be initiated between self-service kiosk control computing platform 110 and the one or more sensors 140.

Additionally or alternatively, radio frequency identification may be used to detect the vehicle. For instance, at step 303, radio frequency signals may be transmitted and received between a radio frequency identification device 180 (e.g., arranged in the vehicle) and a radio frequency identification device included in sensors 140. In some examples, radio frequency identification may be used instead of other sensors. In still other examples, radio frequency identification might not be used and step 303 may be optional. In some examples, the radio frequency identification device 180, upon being detected, may be used to retrieve a pre-stored position associated with a user of the radio frequency identification device 180 and stored in, for example, database 112d.

At step 304, sensors 140 may capture data. For instance, one or more sensors 140 may capture dimension data (e.g., overall height from a ground surface, distance from a bottom of a driver side window to a ground surface, height of hood from a ground surface, distance from driver side door of the vehicle to a front face of the self-service kiosk, or the like).

At step 305, the captured data may be transmitted by the sensors 140 to the self-service kiosk control computing platform 110. For example, the sensors 140 may transmit the data during the communication session initiated upon establishing the first wireless connection.

With reference to FIG. 3B, at step 306, user computing device 170 may receive a request to adjust a display of a self-service kiosk. For instance, a user of the user computing device 170 may provide user input (e.g., via a keypad, touchscreen display, or the like) indicating the user is approaching the self-service kiosk and requesting the display adjust based on a pre-stored or previously saved adjusted position.

At step 307, user computing device 170 may connect to self-service kiosk control computing platform 110. For instance, a second wireless connection may be established between user computing device 170 and the self-service kiosk control computing platform 110. Upon establishing the second wireless connection, a communication session may be initiated between self-service kiosk control computing platform 110 and the user computing device 170.

At step 308, the user computing device 170 may transmit the request to adjust the display to the self-service kiosk control computing platform 110. For instance, the request may include user identifying data (e.g., to identify the pre-stored position) and may be transmitted during the communication session initiated upon establishing the second wireless connection.

In some examples, steps 306-308 might not be performed. For instance, a user might not have pre-stored position data or might not make a request to adjust the display and, instead, may rely on captured sensor data or the like. Accordingly, steps 306-308 are optional.

At step 309, self-service kiosk control computing platform 110 may analyze the received sensor data, user request for adjustment (if received), and the like. For instance, data related to a dimension of a vehicle may be received and analyzed to determine an appropriate height, extension distance, or the like, for the movable display portion of the self-service kiosk. In some examples, the dimension data may be received and compared to one or more ranges or thresholds. Based on an identified range or threshold, an appropriate position (e.g., adjusted position or second position) of the movable display portion may be identified.

At step 310, based on the identified adjusted position, an instruction to move the movable display portion to the identified adjusted or second position may be generated.

With reference to FIG. 3C, at step 311, the instruction to move the movable display portion (e.g., display and, in at least some examples, other components) may be executed, causing the movable display portion of the self-service kiosk to physically move, relative to a remainder of the self-service kiosk, from a first position (e.g., a default or most recent position) to the identified adjusted or second position.

At step 312, self-service kiosk control computing platform 110 may receive user input further adjusting the movable display portion. For instance, a user at a self-service kiosk may select one or more options to further adjust (e.g., up, down, in and/or out) the movable portion. The selected option may be a soft key, button associated with the movable portion, keypad key, or the like. The input may allow users to fine tune the movable display portion to a desired position.

At step 313, based on the received user input, self-service kiosk control computing platform 110 may generate and execute an instruction to further adjust the movable display portion as requested by the user.

In some examples, user input further adjusting the movable display portion might not be received and steps 312 and 313 may be optional.

At step 314, self-service kiosk control computing platform 110 may receive user input requesting a transaction. For instance, self-service kiosk control computing platform 110 may receive, from a user and via a card reader of the self-service kiosk, keypad, touch screen display, or the like, a request to initiate a transaction. The user input may include additional selections (e.g., input of authentication data, selection of a type of transaction, or the like) to identify the transaction being requested, identify parameters of the transaction (e.g., amount to withdraw, type of item being deposited, account type for which balance is requested, or the like), and the like.

At step 315, self-service kiosk control computing platform 110 may connect to internal entity computing system 120. For instance, a third wireless connection may be established between internal entity computing system 120 and the self-service kiosk control computing platform 110. Upon establishing the third wireless connection, a communication session may be initiated between self-service kiosk control computing platform 110 and the internal entity computing system 120.

With reference to FIG. 3D, at step 316, self-service kiosk control computing platform 110 may generate a request for data. For instance, account data, user authentication data, and the like, may be requested from, for instance, internal entity computing system 120, to process the requested transaction.

At step 317, the self-service kiosk control computing platform 110 may transmit the request for data to the internal entity computing system 120. For instance, the request for data may be transmitted during the communication session initiated upon establishing the third wireless connection.

At step 318, the internal entity computing system 120 may receive and execute the request for data. For instance, the internal entity computing system 120 may identify and/or extract data responsive to the request.

At step 319, the internal entity computing system 120 may generate response data. For instance, based on the identified or extracted data, internal entity computing system 120 may generate response data.

At step 320, internal entity computing system 120 may transmit the response data to the self-service kiosk control computing platform 110. For instance, the response data may be transmitted during the communication session initiated upon establishing the third wireless connection.

At step 321, self-service kiosk control computing platform 110 may receive the response data from the internal entity computing system 120.

With reference to FIG. 3E, at step 322, based on the received response data, self-service kiosk control computing platform 110 may execute or process the requested transaction. For instance, the self-service kiosk control computing platform 110 may generate and execute one or more instructions causing the self-service kiosk to dispense funds, open a deposit aperture to receive deposit items, display a requested balance, or the like.

At step 323, self-service kiosk control computing platform 110 may detect completion of the transaction. For instance, a user's card may be returned, a receipt may be printed, user input selecting an option to end the transaction, or the like, may be detected by the self-service kiosk control computing platform 110.

At step 324, self-service kiosk control computing platform 110 may generate an instruction to return the movable display portion of the self-service kiosk to a previous position (e.g., from the second, adjusted position to a previous position, a default position, a first position, or the like).

At step 325, the instruction may be executed and the movable portion may physically move (e.g., up, down, inward and/or outward) from the current, adjusted position, to a previous position that may, in some examples, be a default position.

At step 326, in some examples, the position data may be stored in association with the user. Accordingly, upon a user approaching the self-service kiosk on a subsequent trip, the position associated with the user may be retrieved and used to identify the position to which the movable portion should be adjusted.

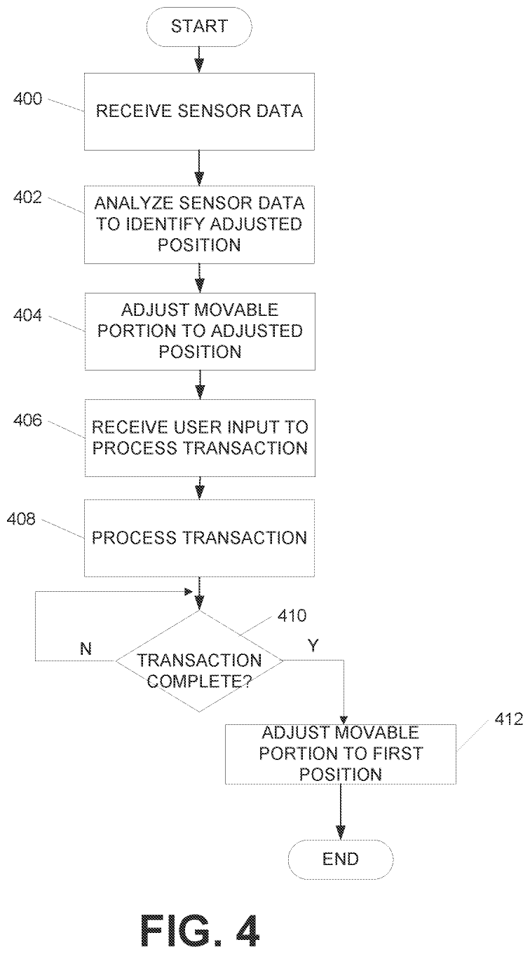

FIG. 4 is a flow chart illustrating one example method of implementing a self-service kiosk with a movable display portion in accordance with one or more aspects described herein. The processes illustrated in FIG. 4 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 4 may be performed in real-time or near real-time.

At step 400, sensor data may be received by a self-service kiosk control computing platform 110 that may be or include a self-service kiosk having a display portion that is movable relative to a remainder of the self-service kiosk. The sensor data may include data associated with a vehicle approaching the self-service kiosk or in proximity to (e.g., within a predefined distance of) the self-service kiosk. The sensor data may include data from one or more sensors arranged at a self-service kiosk and may include LiDAR or laser-based measurement data, motion data from one or more motion sensors, image data from one or more image capture devices, and the like. In some examples, the data may include data from a radio frequency identification device, from a user computing device, such as user computing device 170 or 175, or the like.

At step 402, the received sensor data may be analyzed to identify a second position to which the movable display portion should be physically moved or adjusted from a first position. In some examples, the first position may be a default position. The second position may be identified based on a height dimension of the vehicle determined from the received sensor data, position data of the vehicle (e.g., distance away from a front face of the self-service kiosk or a curb or other structure near the self-service kiosk, and the like.

At step 404, the self-service kiosk control computing platform 110 may generate an instruction to adjust the movable display portion from a current, first position to the identified second, adjusted position. The instruction may be executed causing the movable portion may physically move to the second position.

At step 406, user input requesting a transaction via the self-service kiosk may be received. For instance, a user may initiate a transaction, select transaction parameters, and the like, via one or more input devices (e.g., keypad, touchscreen display, soft keys, or the like) associated with the self-service kiosk.

At step 408, the requested transaction may be processed. For instance, the user may be authenticated based on user authentication data provided, the type of transaction may be identified, a transaction output may be identified and the transaction output may be provided to the user.

At step 410, a determination may be made as to whether the transaction is complete. For instance, the self-service kiosk control computing platform 110 may determine whether an indication of a completed transaction (e.g., user input ending the transaction, dispensing of funds, printing of receipt, or the like) is detected. If not, the process may return to step 410 to subsequently determine whether the transaction is complete.

If the transaction is complete, an instruction causing the movable display portion to adjust from the second, adjusted position to the first position may be generated and executing, thereby causing the movable display portion to return to the first position.

Aspects described herein are directed to a self-service kiosk with a movable display portion. The movable display portion may include the display of the self-service kiosk, as well as one or more other components, such as a keypad, card reader, deposit aperture, cash dispensing aperture, and the like. One or more of the other components may be movable with the movable display portion and relative to a remainder of the self-service kiosk, or may be fixedly connected to a non-movable portion of the self-service kiosk.

As discussed herein, as a vehicle approaches a self-service kiosk, such as a drive-up automated teller machine, sensor data may be captured associated with the vehicle. For instance, LiDAR or other sensor data may be captured indicating one or more dimensions of the vehicle, height or vertical distance between the vehicle and a ground surface, horizontal distance between a driver side of the vehicle and a front surface of the self-service kiosk, or the like. This data may then be analyzed to determine an appropriate position to which the movable display portion will be adjusted to accommodate a driver of the vehicle.

In some examples, data associated with the vehicle may be captured and/or analyzed as the vehicle approaches the self-service kiosk. Additionally or alternatively, the data may be captured and analyzed once the vehicle is stopped relative to the self-service kiosk.

As discussed, various user input devices may be provided with the self-service kiosk. For instance, a card reader that may include ability to read a magnetic strip on a card (e.g., by swiping the card) may be provided, a card reader than may read data from a chip embedded in the card may be provided, and the like. Further, various methods of authenticating the user may be used with the invention. For instance, a user may provide a username and password, personal identification number, biometric data, or the like.

Various aspects described provide for the system to store position data associated with the movable display for a user. Storage of position data, as well as retrieval of the data (e.g., based on user identifiers, vehicle identifiers, radio frequency devices of the user, and the like) are performed with the permission of the user and in accordance with all regulatory requirements.

The arrangements described herein may enable additional security when performing transactions via a self-service kiosk. For instance, by moving the movable portion to a height appropriate for the vehicle and moving the movable portion toward the vehicle (e.g., outward from the self-service kiosk) there is less likelihood of an unauthorized user attempting to grab items the user is inserting into the self-service kiosk or retrieving from the self-service kiosk. Further, the user is less likely to drop items if the movable display is more conveniently positioned relative to the vehicle.

Aspects described herein may also be used with standard security measures in place in self-service kiosks. For instance, secure areas of the self-service kiosk may remain secure without requiring additional security measures as, for instance, deposits will still be received via a same deposit aperture and collected in a secure deposit repository. In some examples, a flexible shoot may be arranged between the aperture and the repository to accommodate any changes based on movement of the movable display portion.

In some examples, additional security aspects may be provided based on a vehicle associated with the user. For instance, if a user is detected (e.g., via radio frequency identification, user input, or the like) but the sensor data indicates that the stored position data does not accommodate the vehicle currently using the self-service kiosk, additional authentication data (e.g., a one time passcode transmitted to a user computing device, additional biometric data, or the like) may be requested from the user to confirm identity. In some examples, machine learning may be used to predict position data based on previous user transactions, position data, and the like.

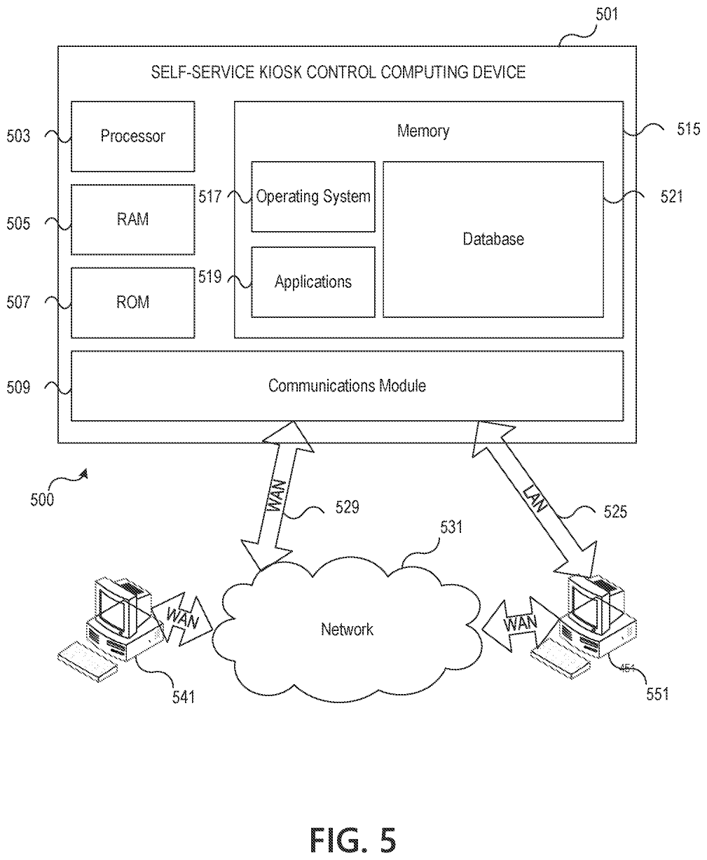

FIG. 5 depicts an illustrative operating environment in which various aspects of the present disclosure may be implemented in accordance with one or more example embodiments. Referring to FIG. 5, computing system environment 500 may be used according to one or more illustrative embodiments. Computing system environment 500 is only one example of a suitable computing environment and is not intended to suggest any limitation as to the scope of use or functionality contained in the disclosure. Computing system environment 500 should not be interpreted as having any dependency or requirement relating to any one or combination of components shown in illustrative computing system environment 500.

Computing system environment 500 may include self-service kiosk control computing device 501 having processor 503 for controlling overall operation of self-service kiosk control computing device 501 and its associated components, including Random Access Memory (RAM) 505, Read-Only Memory (ROM) 507, communications module 509, and memory 515. Self-service kiosk control computing device 501 may include a variety of computer readable media. Computer readable media may be any available media that may be accessed by self-service kiosk control computing device 501, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by self-service kiosk control computing device 501.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on self-service kiosk control computing device 501. Such a processor may execute computer-executable instructions stored on a computer-readable medium.

Software may be stored within memory 515 and/or storage to provide instructions to processor 503 for enabling self-service kiosk control computing device 501 to perform various functions as discussed herein. For example, memory 515 may store software used by self-service kiosk control computing device 501, such as operating system 517, application programs 519, and associated database 521. Also, some or all of the computer executable instructions for self-service kiosk control computing device 501 may be embodied in hardware or firmware. Although not shown, RAM 505 may include one or more applications representing the application data stored in RAM 505 while self-service kiosk control computing device 501 is on and corresponding software applications (e.g., software tasks) are running on self-service kiosk control computing device 501.

Communications module 509 may include a microphone, keypad, touch screen, and/or stylus through which a user of self-service kiosk control computing device 501 may provide input, and may also include one or more of a speaker for providing audio output and a video display device for providing textual, audiovisual and/or graphical output. Computing system environment 500 may also include optical scanners (not shown).

Self-service kiosk control computing device 501 may operate in a networked environment supporting connections to one or more remote computing devices, such as computing devices 541 and 551. Computing devices 541 and 551 may be personal computing devices or servers that include any or all of the elements described above relative to self-service kiosk control computing device 501.

The network connections depicted in FIG. 5 may include Local Area Network (LAN) 525 and Wide Area Network (WAN) 529, as well as other networks. When used in a LAN networking environment, self-service kiosk control computing device 501 may be connected to LAN 525 through a network interface or adapter in communications module 509. When used in a WAN networking environment, self-service kiosk control computing device 501 may include a modem in communications module 509 or other means for establishing communications over WAN 529, such as network 531 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A self-service kiosk, comprising:
a movable display portion, the movable display portion being movable from a first position to a plurality of second positions;
at least one processor;
a communication interface communicatively coupled to the at least one processor; and
a memory storing computer-readable instructions that, when executed by the at least one processor, cause the self-service kiosk to:
receive sensor data related to a vehicle in proximity to the self-service kiosk;
analyze the sensor data to identify a second position for the movable display portion based on the vehicle; and
based on the identified second position, adjust the movable display portion from the first position to the identified second position.

2. The self-service kiosk of claim 1, wherein the received sensor data includes at least one dimension of the vehicle.

3. The self-service kiosk of claim 2, wherein the at least one dimension of the vehicle is captured using light detection and ranging (LiDAR).

4. The self-service kiosk of claim 1, wherein the first position is a default position.

5. The self-service kiosk of claim 1, further including instructions that, when executed, cause the self-service kiosk to:
receive a request to initiate a transaction;
receive user input via the movable display portion; and
process the requested transaction based on the user input received via the movable display portion.

6. The self-service kiosk of claim 5, further including instructions that, when executed, cause the self-service kiosk to:
detect completion of the requested transaction; and
responsive to detecting completion of the requested transaction, further adjust the movable display portion from the identified second position to the first position.

7. The self-service kiosk of claim 1, wherein the movable display portion further includes at least one of: a deposit aperture, a card reader or a keypad that are adjustable with the movable display portion.

8. The self-service kiosk of claim 1, wherein adjusting the movable display portion from the first position to the identified second position causes the movable display portion to physically move relative to a remainder of the self-service kiosk.

9. A method, comprising:
receiving, by a self-service kiosk, the self-service kiosk having a movable display portion movable from a first position to a plurality of second positions, at least one processor, and memory, sensor data related to a vehicle in proximity to the self-service kiosk;
analyzing, by the at least one processor, the sensor data to identify a second position for the movable display portion based on the vehicle; and
based on the identified second position, adjusting, based on instructions executed by the at least one processor, the movable display portion from the first position to the identified second position.

10. The method of claim 9, wherein the received sensor data includes at least one dimension of the vehicle.

11. The method of claim 10, wherein the at least one dimension of the vehicle is captured using light detection and ranging (LiDAR).

12. The method of claim 9, wherein the first position is a default position.

13. The method of claim 9, further including:
receiving, by the at least one processor, a request to initiate a transaction;
receiving, by the at least one processor, user input via the movable display portion; and
processing, by the at least one processor, the requested transaction based on the user input received via the movable display portion.

14. The method of claim 13, further including:
detecting, by the at least one processor, completion of the requested transaction; and
responsive to detecting completion of the requested transaction, further adjusting, based on instructions executed by the at least one processor, the movable display portion from the identified second position to the first position.

15. The method of claim 9, wherein the movable display portion further includes at least one of: a deposit aperture, a card reader or a keypad that are adjustable with the movable display portion.

16. The method of claim 9, wherein adjusting the movable display portion from the first position to the identified second position causes the movable display portion to physically move relative to a remainder of the self-service kiosk.

17. One or more non-transitory computer-readable media storing instructions that, when executed by a self-service kiosk comprising a movable display portion movable from a first position to a plurality of second positions, at least one processor, memory, and a communication interface, cause the self-service kiosk to:
receive sensor data related to a vehicle in proximity to the self-service kiosk;
analyze the sensor data to identify a second position for the movable display portion based on the vehicle; and
based on the identified second position, cause the movable display portion to adjust from the first position to the identified second position.

18. The one or more non-transitory computer-readable media of claim 17, wherein the received sensor data includes at least one dimension of the vehicle.

19. The one or more non-transitory computer-readable media of claim 18, wherein the at least one dimension of the vehicle is captured using light detection and ranging (LiDAR).

20. The one or more non-transitory computer-readable media of claim 17, further including instructions that, when executed, cause the self-service kiosk to:
receive a request to initiate a transaction;
receive user input via the movable display portion; and
process the requested transaction based on the user input received via the movable display portion.

21. The one or more non-transitory computer-readable media of claim 20, further including instructions that, when executed, cause the self-service kiosk to:
detect completion of the requested transaction; and
responsive to detecting completion of the requested transaction, further cause the movable display portion to adjust from the identified second position to the first position.

22. The one or more non-transitory computer-readable media of claim 17, wherein the movable display portion further includes at least one of: a deposit aperture, a card reader or a keypad that are adjustable with the movable display portion.
